(19) United States
(12) Patent Application Publication
(10) Pub. No.: US 2020/0329642 A1
(43) Pub. Date: Oct. 22, 2020

(54) FLOWER POT

(71) Applicant: GLOBE CORPORATION, Ibaraki (JP)

(72) Inventor: Kounosuke Horiuchi, Ibaraki (JP)

(21) Appl. No.: 16/643,271

(22) PCT Filed: Dec. 12, 2017
(86) PCT No.: PCT/JP2017/044598

§ 371 Date: Feb. 28, 2020

(30) Foreign Application Priority Data
Aug. 28, 2017 (JP) 2017-163766

(51) Int. Cl. A01G 9/02

(52) U.S. Cl. CPC A01G 9/02; A01G 2009/003

(57) ABSTRACT

The present invention relates to a flower pot of a double structure comprised of an inner container and an outer container. The present invention relates in particular to a flower pot of a double structure comprised of an inner container and an outer container, in which an inside container for planting a plant is designed to be transparent so that how the plant is rooted or watered is observable, and the interior of the pot is completely shielded from the light by preventing the light from entering from above and an outside container covering the pot is completely shielded from the light so that moss is suppressed from being grown on the inner surface of the pot and the plant can be grown in a most suitable environment without applying the light to the roots.

The pot is of a double structure comprised of the inner container 11 and the outer container 21 disposed outside the inner container 11. The inner container 11 is transparent and an upper part of the inner container is shielded from the light and the outer container 21 is colored in a completely lightproof color or formed of a completely lightproof material.

### CROSS REFERENCE TO RELATED APPLICATION

The present application is based on and claims the benefit of priority of International Application No. PCT/JP2017/044598, filed on Dec. 12, 2017, which claims priority to Japanese Patent Application No. 2017-163766, filed on Aug. 28, 2017, the entire contents of which is incorporated herein by reference.

### TECHNICAL FIELD

The present invention relates to a flower pot.

The present invention relates in particular to a flower pot of a double structure comprised of an inner container and an outer container. The present invention relates in more particular to a flower pot in which an inside container for planting a plant is designed to be transparent so that how the plant is rooted or watered is observable. Further, the interior of the pot is completely shielded from the light by preventing the light from entering from above and an outside container covering the pot is completely shielded from the light so that moss is suppressed from being grown on the inner surface of the pot and the plant can be grown in a most suitable environment without applying the light to the roots.

### BACKGROUND ART

Ordinary flower pots are so structured that the roots of plants are invisible. Therefore, a condition of roots of a plant and a degree of watering are difficult to check.

There is an idea of planting a plant in a transparent pot made of glass. This brings about a seemingly good appearance. However, the interior will be covered with moss and become invisible with long-time use and the appearance of the entire pot will become deteriorated. Further, the pot itself will become unusable.

Patent Document 1 (Japanese Unexamined Patent Application Publication No. Hei 5(1993)-292839) describes a “flower pot” in which “the conditions of growth of roots and soil can be observed as required without hindering growth of a plant.” The flower pot is constructed by “extractably inserting a transparent inner container 20 into an opaque outer container 10. The conditions of growth of roots of a plant and soil in the inner container can be easily observed as required by pulling the inner container 20 from the outer container 10.”

Patent Document 2 (Japanese Unexamined Patent Application Publication No. 2004-81089) describes a “flower pot with a side face of a transparent container shielded from the light with a sheet.” “The flower pot is simple in structure and allows the conditions of watering of bed soil and rooting can be freely observed without damaging the roots of a plant in the pot. The convenient flower pot facilitates the watering and makes a saucer of the pot unnecessary because of no leak of water.” A “light-tight sheet (2) provided with an observation window is attached to a see-through pot side wall (1b). A drain pipe wall (3) with an openable drain port (3a) at a pot rim (1a) is added to a part of the pot side wall (1b) and a part of a pot bottom portion (1c) to form a cavity and the pot is placed in a soil holding portion.”

Patent Document 3 (Japanese Unexamined Patent Application Publication No. Hei 9(1997)-191770) describes a “double flower pot.” It described that: “in conventional double flower pots, water is supplied also from a side face of an inner container body; therefore, a quantity of water retained in the entire soil in the inner container body is increased and this is prone to result in root rot of a plant, but the disclosed invention is a double flower pot in which time and trouble for watering can be saved for a long time and a quantity of water retained in the entire inner container body is prevented from being increased.” Further, “the double flower pot includes: an outer container body 2 whose side face at least partly has a transparent portion extending from an upper part to a lower part; an inner container body 1 placed in the outer container body 2 with a gap in between and having a leg portion 12; and a lid portion 3 covering an opening of a gap portion I formed by the inner container body 1 and the outer container body 2, and the lid portion 3 includes an opening/closing portion that has a hinge or a bending portion, can be opened/closed, and provides an opening to the gap portion, the inner container body 1 is provided at its bottom portion with a plurality of water supply ports (approximately 0.2 to 0.3 ports/cm2) 11, 0.5 to 3 mm in diameter, and the gap portion I formed by the outer container body 2 and the inner container body 1 provides a water supply chamber.”

Patent Document 4 (Japanese Unexamined Patent Application Publication No. 2004-33175) describes a “transparent flower pot with a light-tight cover” which “allows the growth and proliferation of roots of a plant to be externally observed and further the growing to be appropriately managed.” Further, “the flower pot enabling the growth of roots of a plant is made of a transparent material and is so configured that an outer side face of the flower pot can be covered with the detachable light-tight cover.”

### CITATION LIST

### Patent Documents

[Patent Document 1] Japanese Unexamined Patent Application Publication No. Hei 5(1993)-292839

[Patent Document 2] Japanese Unexamined Patent Application Publication No. 2004-81089

[Patent Document 3] Japanese Unexamined Patent Application Publication No. Hei 9(1997)-191770

[Patent Document 4] Japanese Unexamined Patent Application Publication No. 2004-33175

### SUMMARY OF THE INVENTION

### Problems to Solved by the Invention

In conventional flower pots, a state beneath the soil surface is invisible. For this reason, how water is impregnated cannot be seen because of a difference in soil texture and the presence/absence of water is determined by observing only the surface of soil for watering. As a result, there are cases where sufficient water is still retained in soil even though the surface of soil is dried. In such a case, water may be supplied even when watering is still unnecessary and root rot can result.

In cases where bottom watering is required, water is stored in a saucer; moss is grown in the stored water and the appearance is deteriorated. Further, insects, such as mosquito larvae, are bred in the stored water and the environment is deteriorated.

In cases where a plant is grown using only a transparent pot, moss is grown on the inner surface of the pot, making the interior of the pot difficult to view and deteriorating the appearance of the pot.

Each of the “flower pot” in Patent Document 1, the “flower pot with a side face of a transparent container shielded from the light with a sheet” in Patent Document 2, the “double flower pot” in Patent Document 3, and the “transparent flower pot with a light-tight cover” in Patent Document 4 includes a transparent portion and a non-transparent portion. However, the exterior of each of these flower ports is insufficiently lightproof. Further, even when the light is applied to a part of a transparent portion, the light is transmitted to the entire transparent portion. As a result of this phenomenon, the interior of the pot is irradiated with the light and the growth of roots is prevented. Moss is grown and makes the growth of roots and a state of watering difficult to check. A moss-grown pot requires cleaning.

### Solution to Problems

The present invention solves these problems and provides a flower pot characterized in that: an outer part of a double structure of the pot is made lightproof and an inner part is made transparent and the upper part of the inner part is made lightproof, the entry of the light into the pot due to transmission of the light thereby being completely prevented.

### Advantageous Effects of the Invention

The present invention solves these problems and has the same functions as conventional flower pots. Further, the present invention hardly requires pot cleaning and allows the favorable visibility to be maintained for a long time so that the growth and density of roots of a plant, timing of transplanting, a state of water retained in soil can be observed. As a result, even a plant difficult to cultivate can be easily grown and the flower pot is most suitable for learning and research and has high general versatility in terms of design. The present invention provides a flower pot of a structure satisfying all the above-mentioned requirements.

### BRIEF DESCRIPTION OF THE DRAWINGS

FIG. 1 is a front view of an inner container and an outer container combined with each other in a first example of an embodiment of the present invention;

FIG. 2 is a perspective view of an inner container and an outer container combined with each other in the first example of the embodiment of the present invention;

FIG. 3 is a front view of an inner container in the first example of the embodiment of the present invention;

FIG. 4 is a front view of an outer container in the first example of the embodiment of the present invention;

FIG. 5 is a front cross-sectional view of an inner container and an outer container combined with each other in the first example of the embodiment of the present invention;

FIG. 6 is a perspective view of an inner container and an outer container combined with each other in a second example of the embodiment of the present invention;

FIG. 7 is a perspective view of an inner container and an outer container combined with each other in a third example of the embodiment of the present invention;

FIG. 8 is a perspective view of an inner container and an outer container combined with each other in a fourth example of the embodiment of the present invention;

FIG. 9 is a perspective view of an inner container and an outer container combined with each other in a fifth example of the embodiment of the present invention;

FIG. 10 is a front view of an inner container and an outer container combined with each other in a sixth example of the embodiment of the present invention;

FIG. 11 is a front view of an inner container and an outer container combined with each other in a seventh example of the embodiment of the present invention;

FIG. 12 is a front cross-sectional view of an inner container and an outer container combined with each other in an eighth example of the embodiment of the present invention;

FIG. 13 is a partially enlarged perspective view of an inner container in the eighth example of the embodiment of the present invention;

FIG. 14 is a perspective view of an inner container and an outer container combined with each other in a ninth example of the embodiment of the present invention;

FIG. 15 is a perspective view of an inner container and an outer container separated from each other in a 10th example of the embodiment of the present invention; and

FIG. 16 is a perspective view of an inner container and an outer container separated from each other in an 11th example of the embodiment of the present invention.

### BEST MODE FOR CARRYING OUT THE INVENTION

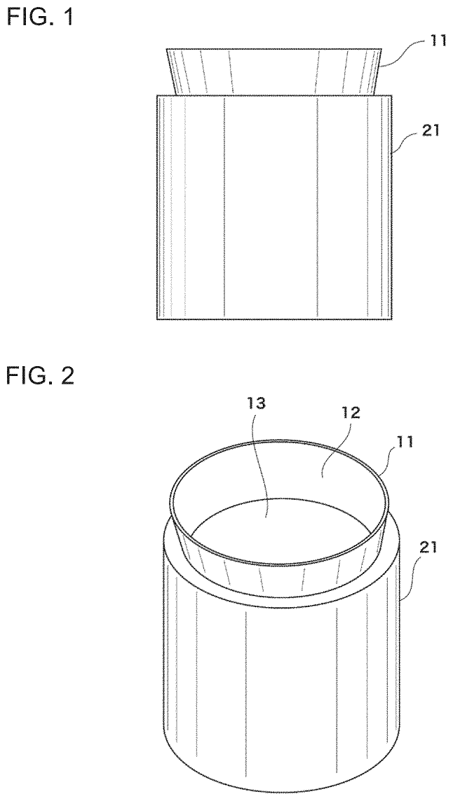

A description will be given to a first example with reference to FIG. 1 to FIG. 5 illustrating the first example.

Reference numeral 11 denotes an inner container of a flower pot. Reference numeral 21 denotes an outer container. Both the containers are made of plastic. The present invention is of a double structure comprised of the inner container 11 as an inside pot and the outer container 21 as an outside pot disposed outside the inner container 11.

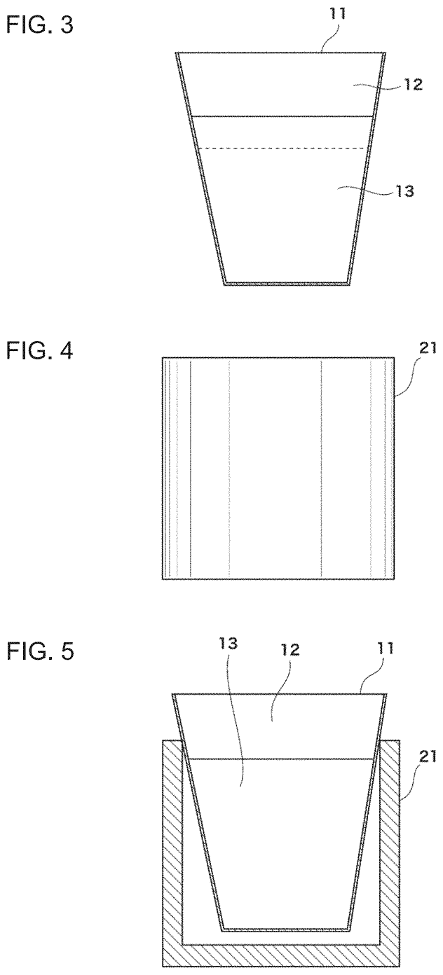

As shown in FIG. 3, FIG. 5, and the like, the inner container 11 is comprised of a transparent portion 13 generally transparent except an upper part. A light-tight portion 12 extended from an opening toward the transparent portion 13 positioned below is provided above the transparent portion 13 of the inner container 11, along the opening like a belt. The light-tight portion 12 is colored in a lightproof color or formed of a lightproof material. The transparent portion 13 is formed of transparent plastic or glass. A material of the light-tight portion 12 is a plastic containing lightproof pigment or any other lightproof material. Any paint may be used as long as the paint is lightproof.

The outer container 21 is colored in a lightproof color or formed of a lightproof material. The outer container 21 is preferably colored in a completely lightproof color or formed of a completely lightproof material. The dryness of a soil surface can be checked from above the inner container 11. When soil placed in the inner container 11 is shallow and the surface of soil is close to the opening of the inner container 11, the light can enter from above the inner container 11.

The light-tight portion 12 provided in the inner container 11 is extended to below a point of contact with the outer container 21. The light-tight portion 12 may be of any pattern, color, or shape as long as light blocking is ensured.

The inner container 11 and the outer container 21 may be of any design, including shape, color, and the like.

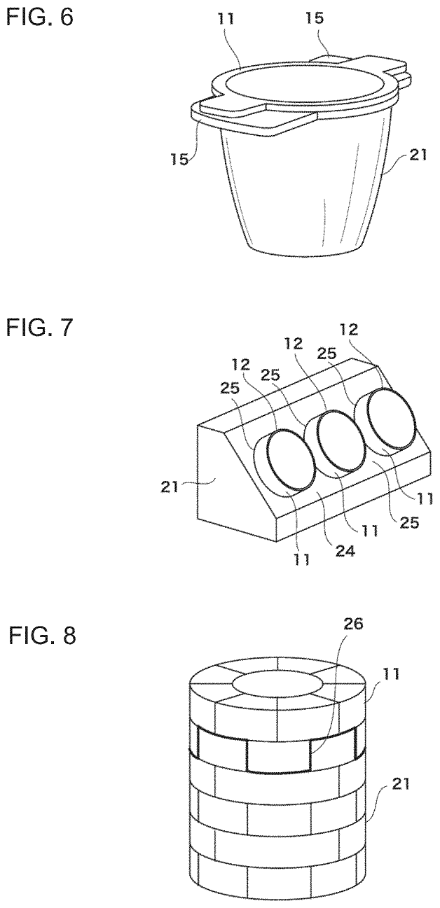

In a second example shown in FIG. 6, two opposite flanges 15 horizontally extended from an upper part of the inner container 11 are provided. The shape of the second example is most suitable for large-sized pots and lifting is facilitated both when only the inner container 11 is lifted and when the inner container 11 and the outer container 21 are lifted at the same time.

In a third example shown in FIG. 7, the outer container 21 is formed of a box having a substantially pentagonal side face. One face of the box is sloped and the sloped face 24 is provided with three holes 25. An inner container 11 is inserted into each of the holes 25 with the light-tight portion 12 of the inner container exposed.

In a fourth example shown in FIG. 8, the circumferential surfaces of the inner container 11 and the outer container 21 have a brick-like appearance. In the fourth example, the opening at the upper part of the outer container 21 is convexo-concave in accordance with the shape of bricks. The lower side of the inner container 11 is convexo-concave in accordance with the convexo-concave of the outer container 21 so that the lower side of the inner container 11 can be engaged with the opening of the outer container 21.

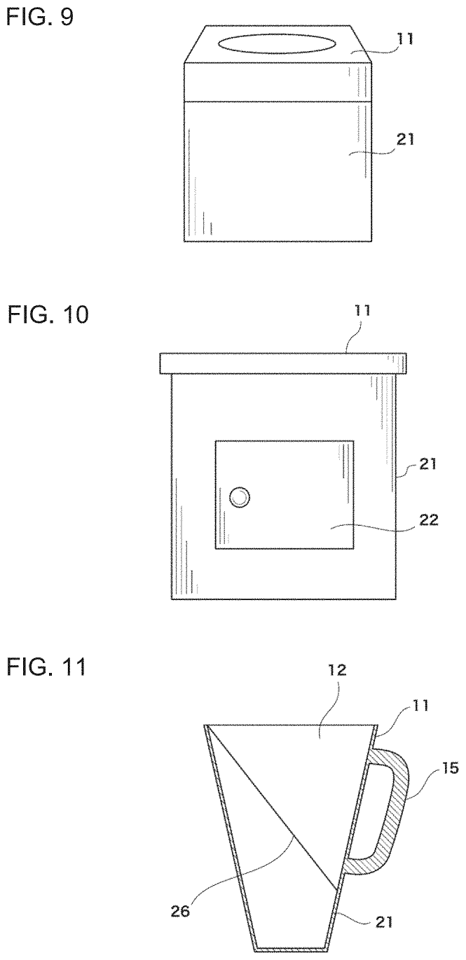

In a fifth example shown in FIG. 9, the outer container 21 is cubic and the inner container 11 is so shaped that an upper side of the inner container constitutes a part of the cube.

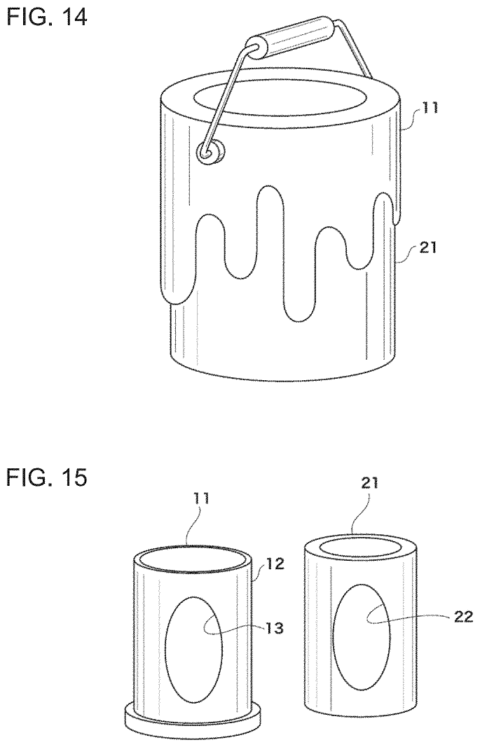

In a ninth example shown in FIG. 14, the inner container 11 and the outer container 21 are in the shape of a paint can with paint running down the exterior. A part where the paint runs down the exterior is equivalent to the light-tight portion 12 of the inner container 11. A part positioned below the part where the paint runs down the exterior is equivalent to the outer container 21.

As mentioned above, the design of the inner container 11 and the outer container 21 in the examples are rich in variety.

In a sixth example shown in FIG. 10, reference numeral 22 denotes an openable door provided in the outer container 21. The outer container has a window that is provided in a side face of the light-tight flower pot, formed of a transparent material so that the content can be viewed, and closed with the openable door 22. The light-tight portion 12 completely shields the light.

In the sixth example, the outer container 21 is provided with the openable door or lid such as the door 22; therefore, the content can be observed without lifting the inner container 11.

A seventh example shown in FIG. 11 is in the shape of a cup as a whole. Reference numeral 15 denotes a handle. In the seventh example, the contact surface between the inner container 11 and the outer container 21 is structured like an aslant cut. The handle 15 is grabbed and the cup-like inner container 11 is inserted into the case-like outer container 21.

In the seventh example, the opening 26 of the outer container 21 is provided slantwise. The light-tight portion 12 of the inner container 11 is provided slantwise in accordance with the slantwise opening 26 of the outer container 21. The other part of the inner container 11 than the light-tight portion 12 is configured as the transparent portion 13.

Since the inner container 11 is provided with the handle, the inner container 11 can be easily lifted even when a weeping plant is planted.

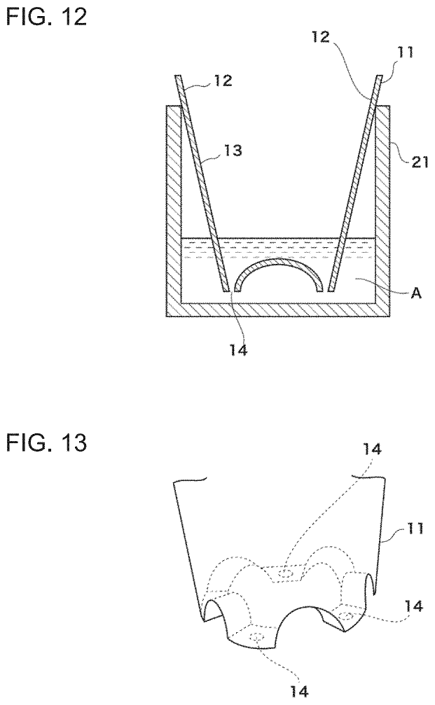

In an eighth example whose general view is shown in FIG. 12 and the bottom portion of the inner container 11 of which is shown in FIG. 13 in an enlarged manner, the inner container 11 is provided at the bottom portion of the transparent portion 13 with a drain hole 14 as shown in the drawings. Since the drain hole 14 is provided, water can be stored in the outer container 21 and the outer container 21 can be used as a bottom watering saucer. Reference sign A denotes bottom watering water.

For a hole at the bottom portion of the inner container 11, a cut area that can be opened as required can be provided or the hole can be made openable so that the presence or absence of the hole can be selected according to a user's need. Thus, the range of usage of the pot is extended.

In a 10th example shown in FIG. 15, the inner container 11 is cylindrical and is provided at the central part of its side face with an oval transparent portion 13. The outer container 21 is also comprised of a cylinder whose inside diameter is larger than the outside diameter of the inner container 11. The outer container 21 is also provided at the central part of its side face with an oval transparent door 22.

The outer container 21 is placed over the inner container 11 and the door 22 is rotated. By making the door rotatable to enable light shielding and observation, a large size or a heavy weight can be coped with.

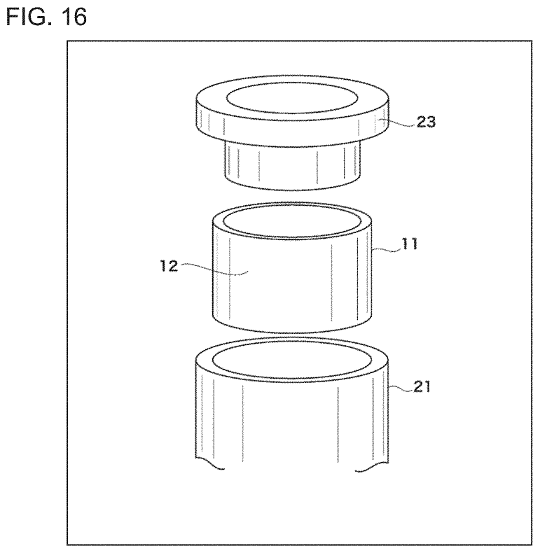

In an 11th example shown in FIG. 16, a light-tight cover 23 separated from the inner container 11 is placed over the inner container 11. In this case, the inner container 11 is comprised only of the transparent portion 12. Use of the light-tight cover allows an upper part of the inner container 11 to be shielded from the light.

In these examples comprised of the inner container 11 and the outer container 21, the same functions as conventional flower pots can be performed. Further, while favorable visibility can be maintained for a long time with almost no need for pot cleaning, the growth and density of roots of a plant, timing of transplanting, and a state of water retained in soil can be observed.

For this reason, a plant difficult to cultivate can be easily grown and these flower pots are most suitable for learning and research and have high general versatility in terms of design. According to the present invention, a flower pot of a structure satisfying all the above-mentioned requirements is provided.

### LIST OF REFERENCE SIGNS

11 Inner container
12 Light-tight portion
13 Transparent portion
21 Outer container
22 Door

1. A pot of a double structure comprised of an inner container and an outer container disposed outside the inner container,
wherein the inner container is transparent and an upper part of the inner container is shielded from the light and the outer container is colored in a lightproof color or formed of a lightproof material.

2. The pot of claim 1, wherein the outer container is colored in a completely lightproof color or formed of a completely lightproof material.

3. The pot of claim 1, further comprising
a window provided in a side face of a light-tight flower pot, formed of a transparent material, provided so that the content is visible, and closed with an openable door.

4. The pot of claim 2, further comprising
a window provided in a side face of a light-tight flower pot, formed of a transparent material, provided so that the content is visible, and closed with an openable door.
